(19) United States
(12) Patent Application Publication
(10) Pub. No.: US 2026/0195221 A1
(43) Pub. Date: Jul. 9, 2026

(54) DYNAMIC DATA ACCESS OBJECTS FOR DATA BACKUP AND RECOVERY

(71) Applicant: Rubrik, Inc., Palo Alto, CA (US)

(72) Inventors: Anshul Gupta, Mountain View, CA (US); Suman Swaroop, San Francisco, CA (US); Amelia Vu, Mountain View, CA (US)

(21) Appl. No.: 19/009,857

(22) Filed: Jan. 3, 2025

(51) Int. Cl. G06F 11/14; G06F 16/21

(52) U.S. Cl. CPC G06F 11/1458; G06F 16/212; G06F 2201/80

(57) ABSTRACT

Methods, systems, and devices for data management are described. Software-as-a-service (Saas) applications may host customers'information in a distributed environment that is not directly accessible to the customers. A data management system (DMS) may manage data backup and restoration for a SaaS application and may use dynamic data access objects (DAOs). The DMS may detect the schema of a table retrieved from a SaaS application via an application programming interface (API) and convert the data in the table to a dynamic DAO based on the detected schema. The dynamic DAO may subsequently be converted to an object for storage in a storage environment. To restore data to a SaaS application, the DMS may detect the expected schema for the SaaS application, convert stored data to a dynamic DAO based on the expected schema, and restore the data from the dynamic DAO to the SaaS application via an API.

### FIELD OF TECHNOLOGY

The present disclosure relates generally to data management, including techniques for dynamic data access objects for data backup and recovery.

### BACKGROUND

A data management system (DMS) may be employed to manage data associated with one or more computing systems. The data may be generated, stored, or otherwise used by the one or more computing systems, examples of which may include servers, databases, virtual machines, cloud computing systems, file systems (e.g., network-attached storage (NAS) systems), or other data storage or processing systems. The DMS may provide data backup, data recovery, data classification, or other types of data management services for data of the one or more computing systems. Improved data management may offer improved performance with respect to reliability, speed, efficiency, scalability, security, or ease-of-use, among other possible aspects of performance.

### BRIEF DESCRIPTION OF THE DRAWINGS

FIG. 1 illustrates an example of a computing environment that supports dynamic data access objects (DAOs) for data backup and recovery in accordance with aspects of the present disclosure.

FIG. 2 shows an example of a computing environment that supports dynamic DAOs for data backup and recovery in accordance with aspects of the present disclosure.

FIG. 3 shows an example of a table conversion diagram that supports dynamic DAOs for data backup and recovery in accordance with aspects of the present disclosure.

FIG. 4 shows an example of a process flow that supports dynamic DAOs for data backup and recovery in accordance with aspects of the present disclosure.

FIG. 5 shows a block diagram of an apparatus that supports dynamic DAOs for data backup and recovery in accordance with aspects of the present disclosure.

FIG. 6 shows a block diagram of a DMS manager that supports dynamic DAOs for data backup and recovery in accordance with aspects of the present disclosure.

FIG. 7 shows a diagram of a system including a device that supports dynamic DAOs for data backup and recovery in accordance with aspects of the present disclosure.

FIGS. 8 through 10 show flowcharts illustrating methods that support dynamic DAOs for data backup and recovery in accordance with aspects of the present disclosure.

### DETAILED DESCRIPTION

Software-as-a-Service (Saas) applications (e.g., platforms) may host their customers'information in a distributed environment that is not directly accessible to the customers—e.g., customers of a SaaS application may have access to their associated data only via the SaaS application, such as through one or more application programming interfaces (APIs) associated with the SaaS application. Additionally, many SaaS applications store their customers'data in the form of tables, which may have associated schemas. A table schema may refer to the columns or fields of data that each row of the table includes. A table schema for SaaS data may be unique to a particular SaaS application or portion thereof, may change (e.g., be updated by the SaaS application provider) over time, or any combination thereof.

A data management system (DMS) may manage data backup and restore operations for a SaaS application. For example, to back up SaaS data, the DMS may retrieve SaaS data (e.g., a SaaS table or an object representing data from a SaaS table) via an API and may convert a retrieved table to a static data access object (DAO) based on the expected schema (e.g., to map the data values of the table to the expected columns or fields of the table). For example, a DAO may store data as a runtime map which may be populated by application code. The DAO may subsequently be converted to a table or object in a different format for storage (e.g., for cloud storage). Similarly, for restore operations, the DMS may retrieve data from a storage environment, convert the data into a static DAO based on the expected schema for the restore SaaS application, and then convert the data in the static DAO into the table of the schema for the SaaS application to restore the table to the SaaS application via an API. Static DAOs may hard code the expected schema for a particular SaaS application. Static DAOs may be unable to manage changes (e.g., updates) to the table schema at a SaaS application, however. Accordingly, use of static DAOs may demand recoding of the expected schema when a SaaS application changes schema. Similarly, different static DAOs may be hard coded for each different SaaS application backed up by the DMS and/or for each type of table used by a particular SaaS application. Additionally, or alternatively, static DAOs may be unable to manage partial data (e.g., a table missing one or more expected columns or fields).

Aspects of this disclosure relate to use of dynamic DAOs for data management of SaaS applications. For example, the DMS may detect the schema of a table retrieved from a SaaS application via an API and may convert the data in the table to a dynamic DAO based on the detected schema. For example, the DMS may identify the columns/fields of the table, and the DMS may automatically generate a dynamic DAO that maps the fields/columns to the data values associated with the fields/columns on a per-row basis for the table. The dynamic DAO may subsequently be converted to an object for storage depending on the storage environment. Similarly, to restore data to a SaaS application, the DMS may detect the expected columns/fields for the SaaS application (e.g., based on an API call to the SaaS application), and may convert stored data to a dynamic DAO based on the expected columns/fields for the SaaS application. The DMS may subsequently restore the data from the dynamic DAO to the SaaS application via an API. For example, the source schema (e.g., the schema at the restore environment) may be different than the schema of a backup of a table at a storage environment used for the restore, and dynamic DAOs may enable handling of different schemas between the restore environment and the storage environment. Similarly, schemas at a host environment may change over time, and thus a schema of a first version of table at a first time that was backed up may be different from the expected schema of the table at the restore time. Accordingly, dynamic DAOs may be used with any table format or schema, and thus may be used for data backup and restoration of any SaaS application. In some examples, a dynamic DAO may be used to store the schema of a table without also storing row data. For example, a dynamic DAO may be used to store the schema of a table for restore purposes (e.g., for retrieving data from a storage environment in a format compatible with the target restore environment). As another example, a dynamic DAO may be used to store the schema of a table to track or store changes to table schemas over time (e.g. to show how tables at a production environment were organized at given points in time). As another example, a dynamic DAO may be used to store the schema of a table to subsequently load backup information from a production or source environment into a dynamic DAO based on the detected and stored schema of the table.

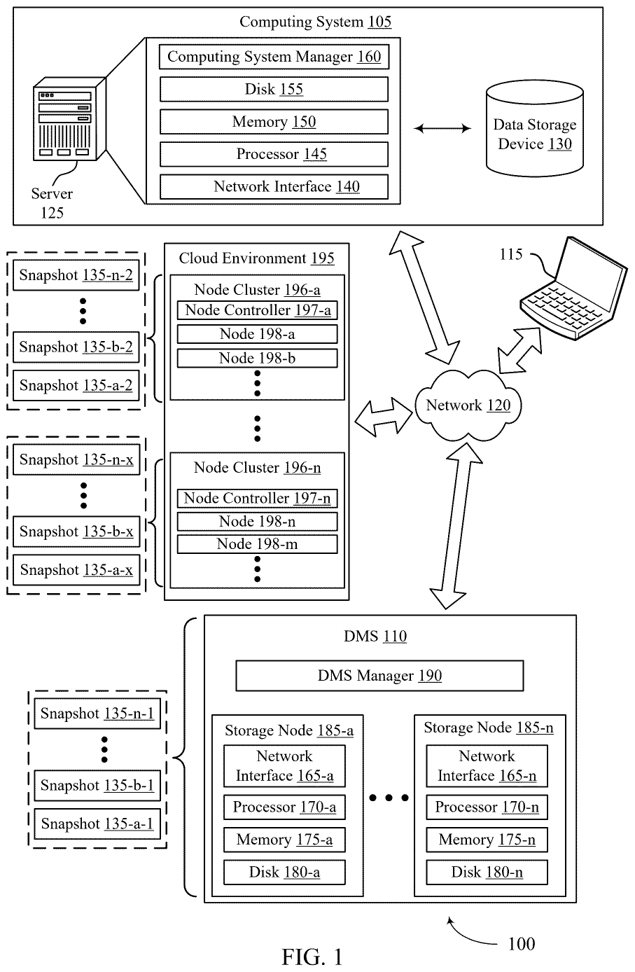

FIG. 1 illustrates an example of a computing environment 100 that supports dynamic DAOs for data backup and recovery in accordance with aspects of the present disclosure. The computing environment 100 may include a computing system 105, a DMS 110, and one or more computing devices 115, which may be in communication with one another via a network 120. The computing system 105 may generate, store, process, modify, or otherwise use associated data, and the DMS 110 may provide one or more data management services for the computing system 105. For example, the DMS 110 may provide a data backup service, a data recovery service, a data classification service, a data transfer or replication service, one or more other data management services, or any combination thereof for data associated with the computing system 105.

The network 120 may allow the one or more computing devices 115, the computing system 105, and the DMS 110 to communicate (e.g., exchange information) with one another. The network 120 may include aspects of one or more wired networks (e.g., the Internet), one or more wireless networks (e.g., cellular networks), or any combination thereof. The network 120 may include aspects of one or more public networks or private networks, as well as secured or unsecured networks, or any combination thereof. The network 120 also may include any quantity of communications links and any quantity of hubs, bridges, routers, switches, ports or other physical or logical network components.

A computing device 115 may be used to input information to or receive information from the computing system 105, the DMS 110, or both. For example, a user of the computing device 115 may provide user inputs via the computing device 115, which may result in commands, data, or any combination thereof being communicated via the network 120 to the computing system 105, the DMS 110, or both. Additionally, or alternatively, a computing device 115 may output (e.g., display) data or other information received from the computing system 105, the DMS 110, or both. A user of a computing device 115 may, for example, use the computing device 115 to interact with one or more user interfaces (e.g., graphical user interfaces (GUIs)) to operate or otherwise interact with the computing system 105, the DMS 110, or both. Though one computing device 115 is shown in FIG. 1, it is to be understood that the computing environment 100 may include any quantity of computing devices 115.

A computing device 115 may be a stationary device (e.g., a desktop computer or access point) or a mobile device (e.g., a laptop computer, tablet computer, or cellular phone). In some examples, a computing device 115 may be a commercial computing device, such as a server or collection of servers. And in some examples, a computing device 115 may be a virtual device (e.g., a virtual machine). Though shown as a separate device in the example computing environment of FIG. 1, it is to be understood that in some cases a computing device 115 may be included in (e.g., may be a component of) the computing system 105 or the DMS 110.

The computing system 105 may include one or more servers 125 and may provide (e.g., to the one or more computing devices 115) local or remote access to applications, databases, or files stored within the computing system 105. The computing system 105 may further include one or more data storage devices 130. Though one server 125 and one data storage device 130 are shown in FIG. 1, it is to be understood that the computing system 105 may include any quantity of servers 125 and any quantity of data storage devices 130, which may be in communication with one another and collectively perform one or more functions ascribed herein to the server 125 and data storage device 130.

A data storage device 130 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 130 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server 125 may host (e.g., provide a database management system for) the database.

A server 125 may allow a client (e.g., a computing device 115) to download information or files (e.g., executable, text, application, audio, image, or video files) from the computing system 105, to upload such information or files to the computing system 105, or to perform a search query related to particular information stored by the computing system 105. In some examples, a server 125 may act as an application server or a file server. In general, a server 125 may refer to one or more hardware devices that act as the host in a client-server relationship or a software process that shares a resource with or performs work for one or more clients.

A server 125 may include a network interface 140, processor 145, memory 150, disk 155, and computing system manager 160. The network interface 140 may enable the server 125 to connect to and exchange information via the network 120 (e.g., using one or more network protocols). The network interface 140 may include one or more wireless network interfaces, one or more wired network interfaces, or any combination thereof. The processor 145 may execute computer-readable instructions stored in the memory 150 in order to cause the server 125 to perform functions ascribed herein to the server 125. The processor 145 may include one or more processing units, such as one or more central processing units (CPUs), one or more graphics processing units (GPUs), or any combination thereof. The memory 150 may comprise one or more types of memory (e.g., random access memory (RAM), static random access memory (SRAM), dynamic random access memory (DRAM), read-only memory (ROM), electrically erasable programmable read-only memory (EEPROM), Flash, etc.). Disk 155 may include one or more HDDs, one or more SSDs, or any combination thereof. Memory 150 and disk 155 may comprise hardware storage devices. The computing system manager 160 may manage the computing system 105 or aspects thereof (e.g., based on instructions stored in the memory 150 and executed by the processor 145) to perform functions ascribed herein to the computing system 105. In some examples, the network interface 140, processor 145, memory 150, and disk 155 may be included in a hardware layer of a server 125, and the computing system manager 160 may be included in a software layer of the server 125. In some cases, the computing system manager 160 may be distributed across (e.g., implemented by) multiple servers 125 within the computing system 105.

In some examples, the computing system 105 or aspects thereof may be implemented within one or more cloud computing environments, which may alternatively be referred to as cloud environments. Cloud computing may refer to Internet-based computing, wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 105 or aspects thereof through SaaS or Infrastructure-as-a-Service (IaaS) services provided by the cloud environment. SaaS may refer to a software distribution model in which applications are hosted by a service provider and made available to one or more client devices over a network (e.g., to one or more computing devices 115 over the network 120). IaaS may refer to a service in which physical computing resources are used to instantiate one or more virtual machines, the resources of which are made available to one or more client devices over a network (e.g., to one or more computing devices 115 over the network 120).

In some examples, the computing system 105 or aspects thereof may implement or be implemented by one or more virtual machines. The one or more virtual machines may run various applications, such as a database server, an application server, or a web server. For example, a server 125 may be used to host (e.g., create, manage) one or more virtual machines, and the computing system manager 160 may manage a virtualized infrastructure within the computing system 105 and perform management operations associated with the virtualized infrastructure. The computing system manager 160 may manage the provisioning of virtual machines running within the virtualized infrastructure and provide an interface to a computing device 115 interacting with the virtualized infrastructure. For example, the computing system manager 160 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 155, the memory, the processor 145, the network interface 140, the data storage device 130, or any combination thereof in support of running the various applications. Storage resources (e.g., the disk 155, the memory 150, or the data storage device 130) that are virtualized may be accessed by applications as a virtual disk.

The DMS 110 may provide one or more data management services for data associated with the computing system 105 and may include DMS manager 190 and any quantity of storage nodes 185. The DMS manager 190 may manage operation of the DMS 110, including the storage nodes 185. Though illustrated as a separate entity within the DMS 110, the DMS manager 190 may in some cases be implemented (e.g., as a software application) by one or more of the storage nodes 185. In some examples, the storage nodes 185 may be included in a hardware layer of the DMS 110, and the DMS manager 190 may be included in a software layer of the DMS 110. In the example illustrated in FIG. 1, the DMS 110 is separate from the computing system 105 but in communication with the computing system 105 via the network 120. It is to be understood, however, that in some examples at least some aspects of the DMS 110 may be located within computing system 105. For example, one or more servers 125, one or more data storage devices 130, and at least some aspects of the DMS 110 may be implemented within the same cloud environment or within the same data center.

Storage nodes 185 of the DMS 110 may include respective network interfaces 165, processors 170, memories 175, and disks 180. The network interfaces 165 may enable the storage nodes 185 to connect to one another, to the network 120, or both. A network interface 165 may include one or more wireless network interfaces, one or more wired network interfaces, or any combination thereof. The processor 170 of a storage node 185 may execute computer-readable instructions stored in the memory 175 of the storage node 185 in order to cause the storage node 185 to perform processes described herein as performed by the storage node 185. A processor 170 may include one or more processing units, such as one or more CPUs, one or more GPUs, or any combination thereof. The memory 150 may comprise one or more types of memory (e.g., RAM, SRAM, DRAM, ROM, EEPROM, Flash, etc.). A disk 180 may include one or more HDDs, one or more SDDs, or any combination thereof. Memories 175 and disks 180 may comprise hardware storage devices. Collectively, the storage nodes 185 may in some cases be referred to as a storage cluster or as a cluster of storage nodes 185.

The DMS 110 may provide a backup and recovery service for the computing system 105. For example, the DMS 110 may manage the extraction and storage of snapshots 135 associated with different point-in-time versions of one or more target computing objects within the computing system 105. A snapshot 135 of a computing object (e.g., a virtual machine, a database, a filesystem, a virtual disk, a virtual desktop, or other type of computing system or storage system) may be a file (or set of files) that represents a state of the computing object (e.g., the data thereof) as of a particular point in time. A snapshot 135 may also be used to restore (e.g., recover) the corresponding computing object as of the particular point in time corresponding to the snapshot 135. In some cases, a computing object that is the subject of a snapshot 135 may be or include a collection of multiple objects (e.g., computing objects may have hierarchical relationships, with lower-level computing objects included within one or more higher-level computing objects). For example, a filesystem may include multiple files, and along with the filesystem being a computing object, the files therein may also be computing objects. Or, as another example, a database may include multiple tables, and along with the database being a computing object, the tables therein may also be computing objects. Thus, a snapshot may be of one or more computing objects, and a snapshot of a first computing object (e.g., a higher-level computing object) may also be a snapshot of each computing object (e.g., each lower-level computing object) that is included in (e.g., is a member or component of) the first computing object. Additionally, a snapshot may be of one or more lower-level computing objects individually (e.g., a snapshot of a lower-level computing object may be separate from another snapshot of another lower-level computing object, separate from another snapshot of a higher-level computing object that contains the lower-level computing object, or both).

A computing object of which a snapshot 135 may be generated may be referred to as snappable. Snapshots 135 may be generated at different times (e.g., periodically or on some other scheduled or configured basis) in order to represent the state of the computing system 105 or aspects thereof as of those different times. In some examples, a snapshot 135 may include metadata that defines a state of the computing object as of a particular point in time. For example, a snapshot 135 may include metadata associated with (e.g., that defines a state of) some or all data blocks included in (e.g., stored by or otherwise included in) the computing object. Snapshots 135 (e.g., collectively) may capture changes in the data blocks over time. Snapshots 135 generated for the target computing objects within the computing system 105 may be stored in one or more storage locations (e.g., the disk 155, memory 150, the data storage device 130) of the computing system 105, in the alternative or in addition to being stored within the DMS 110, as described below.

To obtain a snapshot 135 of a target computing object associated with the computing system 105 (e.g., of the entirety of the computing system 105 or some portion thereof, such as one or more databases, virtual machines, or filesystems within the computing system 105), the DMS manager 190 may transmit a snapshot request to the computing system manager 160. In response to the snapshot request, the computing system manager 160 may set the target computing object into a frozen state (e.g., a read-only state). Setting the target computing object into a frozen state may allow a point-in-time snapshot 135 of the target computing object to be stored or transferred.

In some examples, the computing system 105 may generate the snapshot 135 based on the frozen state of the computing object. For example, the computing system 105 may execute an agent of the DMS 110 (e.g., the agent may be software installed at and executed by one or more servers 125), and the agent may cause the computing system 105 to generate the snapshot 135 and transfer the snapshot 135 to the DMS 110 in response to the request from the DMS 110. In some examples, the computing system manager 160 may cause the computing system 105 to transfer, to the DMS 110, data that represents the frozen state of the target computing object, and the DMS 110 may generate a snapshot 135 of the target computing object based on the corresponding data received from the computing system 105.

Once the DMS 110 receives, generates, or otherwise obtains a snapshot 135, the DMS 110 may store the snapshot 135 at one or more of the storage nodes 185. The DMS 110 may store a snapshot 135 at multiple storage nodes 185, for example, for improved reliability. Additionally, or alternatively, snapshots 135 may be stored in some other location connected with the network 120. For example, the DMS 110 may store more recent snapshots 135 at the storage nodes 185, and the DMS 110 may transfer less recent snapshots 135 via the network 120 to a cloud environment (which may include or be separate from the computing system 105) for storage at the cloud environment, a magnetic tape storage device, or another storage system separate from the DMS 110.

Updates made to a target computing object that has been set into a frozen state may be written by the computing system 105 to a separate file (e.g., an update file) or other entity within the computing system 105 while the target computing object is in the frozen state. After the snapshot 135 (or associated data) of the target computing object has been transferred to the DMS 110, the computing system manager 160 may release the target computing object from the frozen state, and any corresponding updates written to the separate file or other entity may be merged into the target computing object.

In response to a restore command (e.g., from a computing device 115 or the computing system 105), the DMS 110 may restore a target version (e.g., corresponding to a particular point in time) of a computing object based on a corresponding snapshot 135 of the computing object. In some examples, the corresponding snapshot 135 may be used to restore the target version based on data of the computing object as stored at the computing system 105 (e.g., based on information included in the corresponding snapshot 135 and other information stored at the computing system 105, the computing object may be restored to its state as of the particular point in time). Additionally, or alternatively, the corresponding snapshot 135 may be used to restore the data of the target version based on data of the computing object as included in one or more backup copies of the computing object (e.g., file-level backup copies or image-level backup copies). Such backup copies of the computing object may be generated in conjunction with or according to a separate schedule than the snapshots 135. For example, the target version of the computing object may be restored based on the information in a snapshot 135 and based on information included in a backup copy of the target object generated prior to the time corresponding to the target version. Backup copies of the computing object may be stored at the DMS 110 (e.g., in the storage nodes 185) or in some other location connected with the network 120 (e.g., in a cloud environment, which in some cases may be separate from the computing system 105).

In some examples, the DMS 110 may restore the target version of the computing object and transfer the data of the restored computing object to the computing system 105.

And in some examples, the DMS 110 may transfer one or more snapshots 135 to the computing system 105, and restoration of the target version of the computing object may occur at the computing system 105 (e.g., as managed by an agent of the DMS 110, where the agent may be installed and operate at the computing system 105).

In response to a mount command (e.g., from a computing device 115 or the computing system 105), the DMS 110 may instantiate data associated with a point-in-time version of a computing object based on a snapshot 135 corresponding to the computing object (e.g., along with data included in a backup copy of the computing object) and the point-in-time. The DMS 110 may then allow the computing system 105 to read or modify the instantiated data (e.g., without transferring the instantiated data to the computing system). In some examples, the DMS 110 may instantiate (e.g., virtually mount) some or all of the data associated with the point-in-time version of the computing object for access by the computing system 105, the DMS 110, or the computing device 115.

In some examples, the DMS 110 may store different types of snapshots 135, including for the same computing object. For example, the DMS 110 may store both base snapshots 135 and incremental snapshots 135. A base snapshot 135 may represent the entirety of the state of the corresponding computing object as of a point in time corresponding to the base snapshot 135. A base snapshot 135 may alternatively be referred to as a full snapshot 135. An incremental snapshot 135 may represent the changes to the state—which may be referred to as the delta—of the corresponding computing object that have occurred between an earlier or later point in time corresponding to another snapshot 135 (e.g., another base snapshot 135 or incremental snapshot 135) of the computing object and the incremental snapshot 135. In some cases, some incremental snapshots 135 may be forward-incremental snapshots 135 and other incremental snapshots 135 may be reverse-incremental snapshots 135. To generate a base snapshot 135 of a computing object using a forward-incremental snapshot 135, the information of the forward-incremental snapshot 135 may be combined with (e.g., applied to) the information of an earlier base snapshot 135 of the computing object along with the information of any intervening forward-incremental snapshots 135, where the earlier base snapshot 135 may include a base snapshot 135 and one or more reverse-incremental or forward-incremental snapshots 135. To generate a base snapshot 135 of a computing object using a reverse-incremental snapshot 135, the information of the reverse-incremental snapshot 135 may be combined with (e.g., applied to) the information of a later base snapshot 135 of the computing object along with the information of any intervening reverse-incremental snapshots 135.

In some examples, the DMS 110 may provide a data classification service, a malware detection service, a data transfer or replication service, backup verification service, or any combination thereof, among other possible data management services for data associated with the computing system 105. For example, the DMS 110 may analyze data included in one or more computing objects of the computing system 105, metadata for one or more computing objects of the computing system 105, or any combination thereof, and based on such analysis, the DMS 110 may identify locations within the computing system 105 that include data of one or more target data types (e.g., sensitive data, such as data subject to privacy regulations or otherwise of particular interest) and output related information (e.g., for display to a user via a computing device 115). Additionally, or alternatively, the DMS 110 may detect whether aspects of the computing system 105 have been impacted by malware (e.g., ransomware). Additionally, or alternatively, the DMS 110 may relocate data or create copies of data based on using one or more snapshots 135 to restore the associated computing object within its original location or at a new location (e.g., a new location within a different computing system 105). Additionally, or alternatively, the DMS 110 may analyze backup data to ensure that the underlying data (e.g., user data or metadata) has not been corrupted.

The DMS 110 may perform such data classification, malware detection, data transfer or replication, or backup verification, for example, based on data included in snapshots 135 or backup copies of the computing system 105, rather than live contents of the computing system 105, which may beneficially avoid adversely affecting (e.g., infecting, loading, etc.) the computing system 105.

In some examples, the DMS 110, and in particular the DMS manager 190, may be referred to as a control plane. The control plane may manage tasks, such as storing data management data or performing restorations, among other possible examples. The control plane may be common to multiple customers or tenants of the DMS 110. For example, the computing system 105 may be associated with a first customer or tenant of the DMS 110, and the DMS 110 may similarly provide data management services for one or more other computing systems associated with one or more additional customers or tenants. In some examples, the control plane may be configured to manage the transfer of data management data (e.g., snapshots 135 associated with the computing system 105) to a cloud environment 195 (e.g., Microsoft Azure or Amazon Web Services). In addition, or as an alternative, to being configured to manage the transfer of data management data to the cloud environment 195, the control plane may be configured to transfer metadata for the data management data to the cloud environment 195. The metadata may be configured to facilitate storage of the stored data management data, the management of the stored management data, the processing of the stored management data, the restoration of the stored data management data, and the like.

Each customer or tenant of the DMS 110 may have a private data plane, where a data plane may include a location at which customer or tenant data is stored. For example, each private data plane for each customer or tenant may include a node cluster 196 across which data (e.g., data management data, metadata for data management data, etc.) for a customer or tenant is stored. Each node cluster 196 may include a node controller 197 which manages the nodes 198 of the node cluster 196. As an example, a node cluster 196 for one tenant or customer may be hosted on Microsoft Azure, and another node cluster 196 may be hosted on Amazon Web Services. In another example, multiple separate node clusters 196 for multiple different customers or tenants may be hosted on Microsoft Azure. Separating each customer or tenant's data into separate node clusters 196 provides fault isolation for the different customers or tenants and provides security by limiting access to data for each customer or tenant.

The control plane (e.g., the DMS 110, and specifically the DMS manager 190) manages tasks, such as storing backups or snapshots 135 or performing restorations, across the multiple node clusters 196. For example, as described herein, a node cluster 196-a may be associated with the first customer or tenant associated with the computing system 105. The DMS 110 may obtain (e.g., generate or receive) and transfer the snapshots 135 associated with the computing system 105 to the node cluster 196-a in accordance with a service level agreement for the first customer or tenant associated with the computing system 105. For example, a service level agreement may define backup and recovery parameters for a customer or tenant such as snapshot generation frequency, which computing objects to backup, where to store the snapshots 135 (e.g., which private data plane), and how long to retain snapshots 135. As described herein, the control plane may provide data management services for another computing system associated with another customer or tenant. For example, the control plane may generate and transfer snapshots 135 for another computing system associated with another customer or tenant to the node cluster 196-n in accordance with the service level agreement for the other customer or tenant.

To manage tasks, such as storing backups or snapshots 135 or performing restorations, across the multiple node clusters 196, the control plane (e.g., the DMS manager 190) may communicate with the node controllers 197 for the various node clusters via the network 120. For example, the control plane may exchange communications for backup and recovery tasks with the node controllers 197 in the form of transmission control protocol (TCP) packets via the network 120.

The DMS 110 may manage backup and restore operations for one or more SaaS applications (e.g., platforms), such as Salesforce or Jira applications. For example, a computing system 105 may be a SaaS application. As described herein, SaaS applications may host their customers'information in a distributed environment that is not directly accessible to the customers—e.g., customers of a SaaS application may have access to their associated data only via the SaaS application, such as through one or more APIs (e.g., via the network 120). SaaS applications may store customers'data in the form of tables, which may have associated schemas. A table schema for SaaS data may be unique to a particular SaaS application or portion thereof, may change (e.g., be updated by the SaaS application provider) over time, or any combination thereof.

The DMS 110 may use dynamic DAOs for data management of SaaS applications. For example, the DMS may detect the schema of a table retrieved from a SaaS application via an API and may convert the data in the table to a dynamic DAO based on the detected schema. For example, the DMS may identify the columns/fields of the table, and may automatically generate a dynamic DAO that maps the fields/columns to the data values associated with the fields/columns on a per-row basis for the table. The dynamic DAO may subsequently be converted to an object for storage depending on the storage environment.

Similarly, to restore data to a SaaS application, the DMS may detect the expected columns/fields for the SaaS application (e.g., based on an API call to the SaaS application), and may convert stored data to a dynamic DAO based on the expected columns/fields for the SaaS application. The DMS may subsequently restore the data from the dynamic DAO to the SaaS application via an API. Accordingly, dynamic DAOs may be used with any table format or schema, and thus may be used for data backup and restoration of any SaaS application. In some examples, a dynamic DAO may be used to store the schema of a table without also storing row data. For example, a dynamic DAO may be used to store the schema of a table for restore purposes (e.g., for retrieving data from a storage environment in a format compatible with the target restore environment). As another example, a dynamic DAO may be used to store the schema of a table to track or store changes to table schemas over time (e.g. to show how tables at a production environment were organized at given points in time).

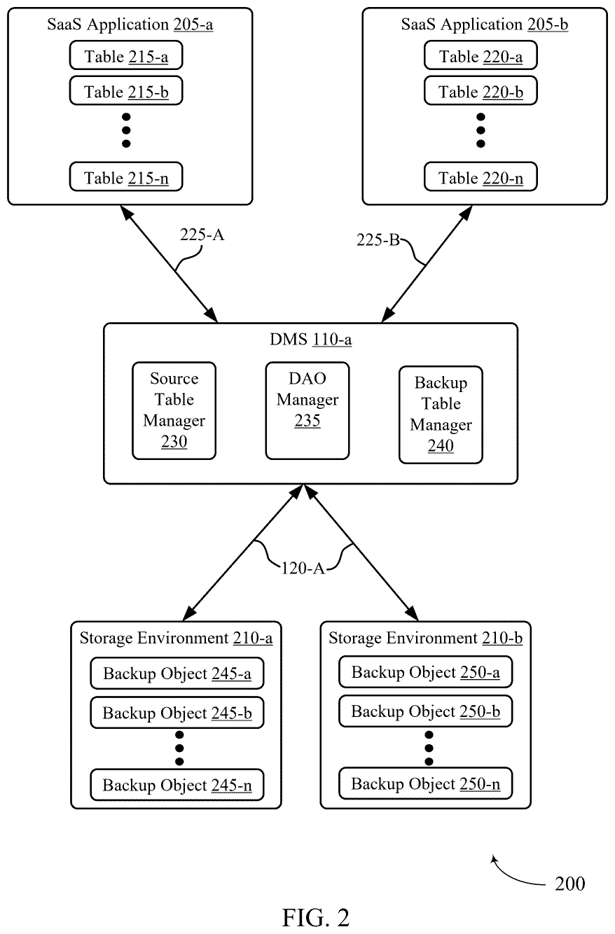

FIG. 2 shows an example of a computing environment 200 that supports dynamic DAOs for data backup and recovery in accordance with aspects of the present disclosure. The computing environment 200 may implement or may be implemented by aspects of the computing environment 100. For example, the computing environment 200 may include a DMS 110-a, which may be an example of a DMS 110 as described herein.

The computing environment 200 may include a SaaS application 205-a and a SaaS application 205-b. For example, the DMS 110-a may provide data management services (e.g., backup and recovery services) for one or more SaaS applications 205. For example, the DMS 110-a may provide data management services for the SaaS application 205-a and the SaaS application 205-b. One or more storage environments 210 may be accessible to the DMS 110-a, for example, via a network 120-a. For example, the storage environments 210 may be examples of one or more storage nodes 185 or one or more node clusters 196 as described herein.

The SaaS application 205-a and the SaaS application 205-b may store data in the form of tables. For example, the SaaS application 205-a may store data in tables 215 (e.g., a table 215-a, a table 215-b, . . . a table 215-n), and the SaaS application 205-b may store data in tables 220 (e.g., a table 220-a, a table 220-b,. a table 220-n). The DMS 110-a may obtain the data in the tables 215 via one or more APIs 225-a (e.g., over the network 120 as described herein), and the DMS 110-a may obtain the data in the tables 215 via one or more APIs 225-a. In some examples, different tables 215 or tables 220 in the same SaaS application 205 may have different schemas. In some examples, table schemas for a same table such as a table 215 or a table 220 may change over time (e.g., columns may be added or deleted).

To support data management services for different or dynamic table schemas, the DMS 110-a may use dynamic DAOs. For example, the DMS 110-a may obtain, at a first time, a table 215-a from the SaaS application 205-a via the API 225-a. The source table manager 230 may obtain the table 215-a as an API object via the API 225-a. The DMS 110-a (e.g., the source table manager 230) may detect the schema of the table 215-a (e.g., the columns/fields of the table 215-a obtained via the API 225-a). The DMS 110-a may convert the table 215-a to one or more DAOs that map the set of fields/columns to corresponding data values per row of one or more rows of data of the source data table. The DMS 110-a may store the one or more DAOs at a DAO manager 235.

The DMS 110-a may convert, for example, using the backup object manager 240, the one or more DAOs to backup objects in a format/schema that may depend on the storage environment 210. For example, different cloud storage providers may use different storage object schemas. In some examples, backup data objects stored locally at the DMS 110-a may use a different format than backup data objects stored at a cloud storage environment (e.g., the storage environment 210-a may be an example of one or more storage nodes 185 and the storage environment 210-b may be an example of one or more node clusters 196). For example, backup objects 245 (e.g., a backup object 245-a, a backup object 245-b,. a backup object 245-n) may have a different schema or format than backup objects 250 (e.g., a backup object 250-a, a backup object 250-b, . . . a backup object 250-n) stored at the storage environment 210-b. The DMS 110-a may convert the one or more DAOs generated for the table 215-a to a backup object based on the target storage environment 210. For example, to store the backup information for the table 215-a at the storage environment 210-a, the backup object manager 240 may convert the one or more DAOs generated for the table 215-a to one or more backup objects 245 and may cause the one or more backup objects 245 to be stored at the storage environment 210-a. Similarly, to store the backup information for the table 215-a at the storage environment 210-b, the backup object manager 240 may convert the one or more DAOs generated for the table 215-a to one or more backup objects 245 and may cause the one or more backup objects 250 to be stored at the storage environment 210-b.

As described herein, the schema of a particular table of a SaaS application may change over time. For example, the DMS 110-a may obtain, at a second time, a second version of the table 215-a from the SaaS application 205-a via the API 225-a (e.g., using the source table manager 230 of the DMS 110-a). The DMS 110-a may (e.g., the source table manager 230) detect the schema of the second version of the table 215-a, which may be different than the first version of the table 215-a at the first time. For example, schemas may change because users may delete fields or columns from tables and/or because SaaS applications may change the way data is stored over time. Such changes may be transparent to the DMS 110-a. The DMS 110-a may convert the second version of the table 215-a to one or more second DAOs that map the set of fields/columns of the second version of the table 215-a to corresponding data values per row of one or more rows of data of the source data table. The DMS 110-a may store the one or more second DAOs at a DAO manager 235. The DMS 110-a may convert, for example, using the backup object manager 240, the one or more second DAOs to backup objects in a format that may depend on the storage environment 210. For example, the DMS 110-a may convert the one or more second DAOs to backup objects 245 for storage at the storage environment 210-a or to backup objects 250 for storage at the storage environment 210-a.

As described herein, different tables in the same SaaS application may have different schemas. For example, the DMS 110-a may obtain, at the first time or at a different second time, the table 215-b from the SaaS application 205-a via the API 225-a (e.g., for using the source table manager 230 of the DMS 110-a). The DMS 110-a may (e.g., the source table manager 230) detect the schema the table 215-b, which may be different than the schema of the table 215-a at the first time. For example, schemas of different tables 215 may be different based on the types of information stored at the different tables (e.g., based on the fields of the different tables 215). The DMS 110-a may convert the table 215-b to one or more second DAOs that map the set of fields/columns of the table 215-b to corresponding data values per row of one or more rows of data of the source data table. The DMS 110-a may store the one or more second DAOs at the DAO manager 235. The DMS 110-a may convert, for example, using the backup object manager 240, the one or more second DAOs to backup objects in a format that may depend on the storage environment 210. For example, the DMS 110-a may convert the one or more second DAOs to backup objects 245 for storage at the storage environment 210-a or to backup objects 250 for storage at the storage environment 210-a.

As described herein, the DMS 110-a may manage data backup operations for multiple different SaaS applications. For example, the DMS 110-a may obtain, at the first time or at a different second time, the table 220-a from the SaaS application 205-b via the API 225-b (e.g., using the source table manager 230 of the DMS 110-a). The DMS 110-a may (e.g., the source table manager 230) detect the schema the table 220-a, which may be different than the schema of the table 215-a at the first time. For example, schemas of different tables for the different SaaS applications 205 may be different based on the types of information stored at the different tables (e.g., based on the fields of the different tables). The DMS 110-a may convert the table 220-a to one or more second DAOs that map the set of fields/columns of the table 220-a to corresponding data values per row of one or more rows of data of the source data table. The DMS 110-a may store the one or more second DAOs at the DAO manager 235. The DMS 110-a may convert, for example, using the backup object manager 240, the one or more second DAOs to backup objects in a format that may depend on the storage environment 210. For example, the DMS 110-a may convert the one or more second DAOs to backup objects 245 for storage at the storage environment 210-a or to backup objects 250 for storage at the storage environment 210-a.

As described herein, the DMS 110-a may manage restore operations for the SaaS applications 205. For example, the DMS 110-a may obtain a request (e.g., via a computing device 115 of a customer of the DMS 110-a) to restore a particular table 215 for the SaaS application 205-a. For example, the DMS 110-a may obtain a request to restore the table 215-a corresponding to a version of the table 215-a at the first time. The DMS 110-a may identify and retrieve the backup information for the table 215-a from storage environment 210-a on which the backup information for the table 215-a at the requested time is stored. For example, the DMS may identify the backup objects 245 and/or the backup objects which include backup information for the table 215-a that corresponds to the requested restore time. The DMS 110-a may retrieve the backup objects 245 and/or the backup objects 250 identified for the requested restore time from the storage environment 210-a and/or the storage environment 210-b. The DMS 110-a may convert the backup objects 245 and/or the backup objects 250 that were retrieved into one or more dynamic DAOs that map fields to one or more rows of data. The DMS 110-a may store the one or more dynamic DAOs at the DAO manager 235. The DMS 110-a may identify a restore schema for the table 215-a at the SaaS application 205-a. For example, the DMS 110-a may perform an API call using the one or more APIs 225-a to identify the restore schema for the table 215-a. The DMS 110-a (e.g., the source table manager 230) may convert the one or more dynamic DAOs to a table having the identified restore schema. The DMS 110-a may accordingly restore the table 215-a via the one or more APIs 225-a.

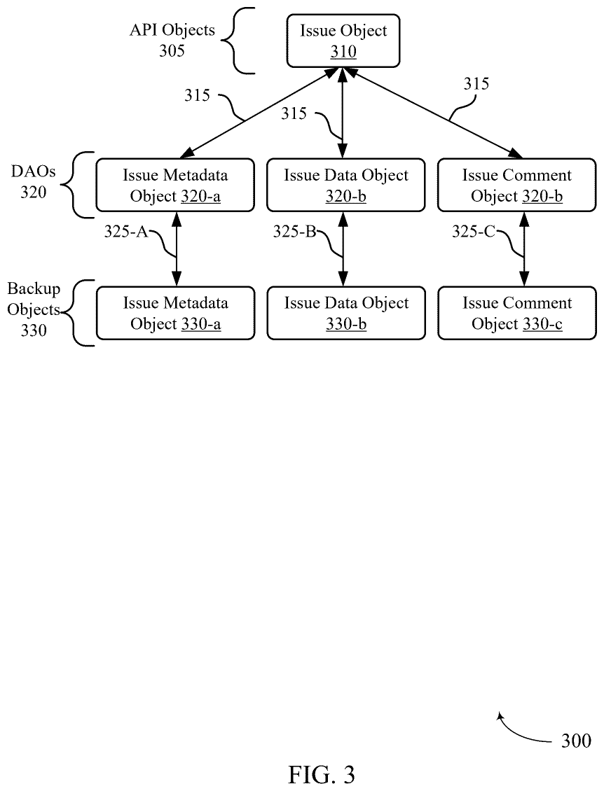

FIG. 3 shows an example of a table conversion diagram 300 that supports dynamic DAOs for data backup and recovery in accordance with aspects of the present disclosure. The table conversion diagram 300 may implement or may be implemented by aspects of the computing environment 100 or the computing environment 200.

As described herein, a DMS 110 may implement dynamic DAOs for backup and restore operations for SaaS applications 205. For example, data ingested from SaaS applications 205 by the DMS 110 may have dynamic, unknown, and/or changing schemas.

The DMS 110 may ultimately store backup data for SaaS applications in Postgres table(s) (e.g., at storage environments 210 as described herein) without forcing SaaS applications to use defined schemas or without managed structures of data. Additionally, use of dynamic DAOs may enable restore operations, as the schema and values from Postgres tables may be loaded into dynamic DAOs which may then be converted to API objects which can be restored via APIs to SaaS applications (e.g., as table(s) at the SaaS application). The use of dynamic DAOs may enable extract, load, and transform (ELT) and extract, transform, and load (ETL) mechanisms for backup and restore operations for different types of structured data and for changing schemas. Dynamic DAOs may be generic and reusable with different SaaS applications. The DMS 110 may implement logic for converting a source API resource into a generic dynamic DAO struct. For example, the source table manager 230 as described with reference to FIG. 2 may identify a schema of an API object (e.g., a table of a SaaS application may be obtained by the DMS 110 as an API object) and may convert the API object into a dynamic DAO based on the detected schema. For example, transformation code 315 may convert an API object 305 into one or more dynamic DAOs that map fields of the API objects 305 to corresponding row values of the API object on a per-row basis. Transformers 324 may convert dynamic DAOs into backup objects (e.g., Zeus objects) which may be stored in a Postgres table for backup. For example, the transformers 325 may be application code and the DAOs may be structured as a runtime map, and accordingly execution of the application code on the DAOs 320 may generate the backup objects 330. Dynamic DAOs may also be recreated using the backup objects 330 (e.g., for restore operations).

The logic to generate DAOs (e.g., the transformation code 315) may be designed as an interface which may encapsulate a minimal amount of information to convey the schema and data of the API object, which may include the names of the columns/fields, the types of columns, and the values of the columns per row. The transformers 325 may be configured to receive arbitrary dynamic DAO values and convert such dynamic DAO values into a Postgres schema, or to mutate an existing schema to obtain a table into which the transformers 325 can write values. The schema of the backup objects 330 may be dependent on a storage format (e.g., based on a particular storage environment). A reverse transformation from the backup objects 330 to a DAO object (e.g., for a restore operation) using the transformers 325 may similarly capture the names of the columns/fields, the types of columns, and the values of the columns per row for the backup objects 330.

As shown in FIG. 3, the DMS 110 may obtain a table from a SaaS application 205 as an API object 305. For example, a particular API object 305 may be an Issue object 310 for a SaaS application 205 (e.g., for a Salesforce application). The Issue object 310 may include multiple sets of fields, including metadata fields, data fields, and comment fields. For example, the metadata fields, data fields, and comment fields may be different types of columns. The DMS 110 (e.g., the source table manager 230) may identify the fields and the types of fields. Accordingly, DAOs may be generate based on identified column/field types. The transformation code 315 may convert the Issue object 310 into DAO(s) 320 (e.g., an issue metadata DAO 320-a which includes the metadata fields of the Issue object 310 mapped to row values on a per-row basis, the issue data DAO 320-b which includes data fields of the Issue object 310 mapped to row values on a per-row basis, and the comment data DAO 320-c which includes comment fields of the Issue object 310 mapped to row values on a per-row basis). A transformer 325-a may transform the issue metadata DAO 320-a to an issue metadata backup object 330-a dependent on the storage environment for backup storage at the storage environment, and vice versa for restore operations. Similarly, a transformer 325-b may transform the issue data DAO 320-b to an issue data backup object 330-b dependent on the storage environment for backup storage at the storage environment, and vice versa for restore operations. A transformer 325-c may transform the issue comment DAO 320-c to an issue comment backup object 330-c dependent on the storage environment for backup storage at the storage environment, and vice versa for restore operations.

As described herein, a DMS 110 may obtain or ingest objects (e.g., tables) from a SaaS application 205 on a per object basis. An API may return a representation of the source object schema in a format exposed by the API. The DMS 110 (e.g., the source table manager 230) may parse attributes of the schema into a usable format for DAOs (e.g., for generation of DAOs(which may convey information regarding the ingested object. For example, a dynamic DAO may convey whether a given column is indexed in the underlying Postgres schema. As an example, for Salesforce, two conditions that may be satisfied in order for indexing the column may be: the corresponding Salesforce field has a filterable attribute set to true; and the length of the field is less than a configurable maximum in order to limit the load on the underlying database. Accordingly, conditions may be configured for inclusion of fields or rows of a table in a dynamic DAO.

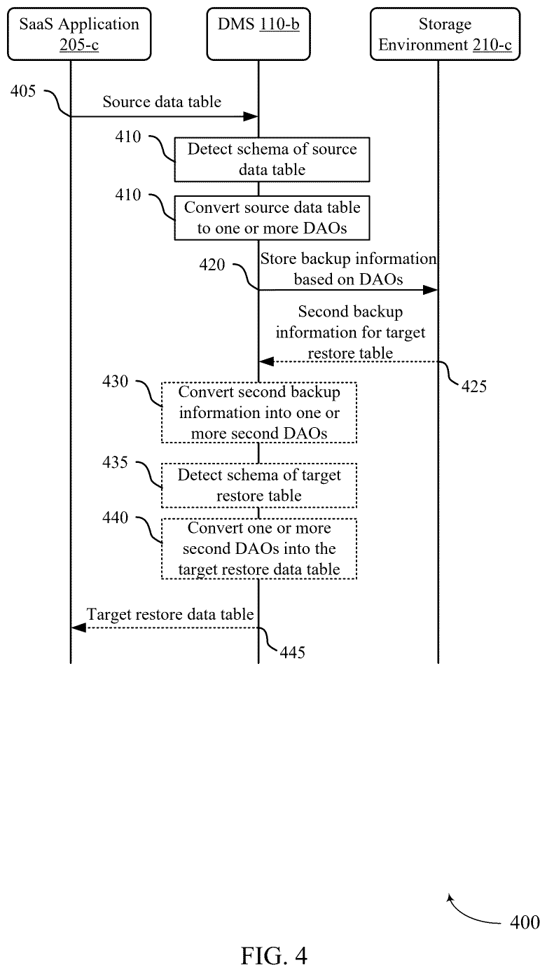

FIG. 4 shows an example of a process flow 400 that supports dynamic DAOs for data backup and recovery in accordance with aspects of the present disclosure. The process flow may implement or may be implemented by aspects of the computing environment 100, the computing environment 200, or the table conversion diagram 300. For example, the process flow 400 may include a SaaS application 205-c, which may be an example of a SaaS application 205 as described herein. The process flow 400 may include a DMS 110-b, which may be an example of a DMS 110 as described herein. The process flow 400 may include a storage environment 210-c, which may be an example of a storage environment 210 as described herein. In the following description of the process flow 400, operations between the SaaS application 205-c, the DMS 110-b, and the storage environment 210-c may be added, omitted, or performed in a different order (with respect to the exemplary order shown).

At 405, the DMS 110-b may obtain a source data table from the SaaS application 205-c via an API associated with the SaaS application 205-c. The source data table may include one or more rows of data values. In some examples, the DMS 110-b may receive, via a user interface associated with the DMS 110-b (e.g., via a computing device 115 associated with an administrative account of the DMS 110-b), a request to back up the source data table of the SaaS application 205-c at a first time, and obtaining the source data table may be at the first time and based on the request. In some examples, the DMS 110-b may be scheduled to obtain backups (e.g., periodic backups) of the SaaS application 205-c and/or one or more tables of the SaaS application 205-c, and obtaining the source data table may be at the first time and based on the schedule.

At 410, the DMS 110-b may detect a schema of the source data table. The schema may include a set of fields.

At 415, the DMS 110-b may convert, based on detecting the schema, the one or more rows of the source data table into one or more respective DAOs that map the set of fields to corresponding data values per row of the one or more rows. In some examples, the one or more respective DAOs may indicate respective field types and respective field names for the set of fields. In some examples, at 415, the DMS 110-b may first convert the source data schema of the source table to a first dynamic DAO and may persist the schema in a backup store (e.g., at the DMS 110-b or at the storage environment 210-c). In some such examples, the DMS 110-b may subsequently ingest data records of the source table, convert the data records to the one or more dynamic DAOs using the persisted schema stored in the first dynamic DAO. The records of the source table and/or the schema of the source table stored in the one or more dynamic DAOs may be written to a backup storage table as described herein.

For example, at 420, the DMS 110-b may cause backup information for the SaaS application 205-c to be stored in the storage environment 210-c. The storage environment 210-c may be accessible to the DMS 110-a (e.g., may be local to the DMS 110-b or accessible to the DMS 110-b via a network connection). The backup information for the SaaS application 205-c may be based on the one or more respective DAOs. In some examples, the DMS 110-b may convert the one or more respective DAOs into one or more backup tables having a second schema, and causing the backup information to be stored in the storage environment may include causing the one or more backup tables having the second schema to be stored in the storage environment 210-c. In some examples, the one or more backup tables having the second schema are Postgres tables. In some examples, less than all of the information in the DAOs may be stored as backup information (e.g., in the case of incremental backup data retention, the DMS 110-b may identify the data which has changed since a previous backup and may store the identified incremental changes).

In some examples, the DMS 110-b may detect relationship metadata associated with the source data table. The relationship metadata may be indicative of a hierarchical relationship or other type of linking relationship between a row of the one or more rows and a second data table. Converting the one or more rows at 415 may include indicating the relationship metadata in a respective DAO for the row of the one or more respective DAOs. For example, in Salesforce SaaS applications, Master Detail relationships may have semantics where if two records are related in a Master Detail relationship, the deletion of the master object triggers automatic deletion of the detail object. Such relationship information may be indicated in the DAOs for the tables obtained by the DMS. For example, inclusion of such relationship information may avoid deletion of a parent object without deletion of a child object (e.g., which may leave such a child object in an orphaned state with a null reference to a parent object).

In some examples, the DMS 110-b may obtain a second source data table from the SaaS application 205-c via the API or a second API associated with the SaaS application, the second source data table including one or more second rows of data values. In some such examples, the DMS 110-b may detect a second schema of the second source data table. The second schema may include a second set of fields different than the set of fields. In some such examples, the DMS 110-b may convert, based on detecting the second schema, the one or more second rows of the second source data table into one or more second respective DAOs that map the second set of fields to corresponding second data values per row of the one or more second rows. In some such examples, the DMS 110-b may cause second backup information for the SaaS application 205-c to be stored in the storage environment 210-c or a second storage environment accessible to the DMS 110-b. The second backup information for the SaaS application may be based on the one or more second respective DAOs.

In some examples, the DMS 110-b may obtain a second source data table from a second SaaS application via a second API associated with the second SaaS application, the second source data table including one or more second rows of data values. For example, the DMS 110-b may provide backup and recovery services for multiple SaaS applications. In some such examples, the DMS 110-b may detect a second schema of the second source data table. The second schema may include a second set of fields different than the set of fields. In some such examples, the DMS 110-b may convert, based on detecting the second schema, the one or more second rows of the second source data table into one or more second respective DAOs that map the second set of fields to corresponding second data values per row of the one or more second rows. In some such examples, the DMS 110-b may cause second backup information for the second SaaS application to be stored in the storage environment 210-c or a second storage environment accessible to the DMS 110-b. The second backup information for the second SaaS application may be based on the one or more second respective DAOs.

In some examples, the DMS 110-b may obtain, at a second time after obtaining the source data table at 405, a second version of the source data table from the SaaS application 205-c via the API associated with the SaaS application. The second version of the source data table obtained at the second time may include one or more second rows of data values. In some such examples, the DMS 110-b may detect a second schema of the second version of the source data table. The second schema may include a second set of fields different than the set of fields. For example, the second set of fields may include a first additional field with respect to the set of fields, or the set of fields may include a second additional field with respect to the second set of fields. In some such examples, the DMS 110-b may convert, based on detecting the second schema, the one or more second rows of the second version of the source data table into one or more second respective DAOs that map the second set of fields to corresponding second data values per row of the one or more second rows. In some such examples, the DMS 110-b may cause second backup information for the SaaS application 205-c to be stored in the storage environment 210-c or a second storage environment accessible to the DMS 110-b. The second backup information for the SaaS application may be based on the one or more second respective DAOs.

In some examples, at 425, the DMS 110-b may obtain, from the storage environment 210-c, second backup information for a target restore data table of the SaaS application that corresponds to a target restore time. For example, the DMS 110-b may receive, via a user interface associated with the DMS 110-b (e.g., via a computing device 115 associated with an administrative account of the DMS 110-b), a request to restore the target restore data table of the SaaS application to a state corresponding to the target restore time. In some such examples, at 430, the DMS 110-b may convert the second backup information for the SaaS application 205-c into one or more second respective DAOs that map a second set of fields of the second backup information to corresponding second data values per row of one or more second rows of the second backup information. In some such examples, at 435, the DMS 110-b may detect a second schema for the target restore data table, the second schema comprising a third set of fields. For example, the DMS 110-b may perform a query to the SaaS application 205-c for the target restore data table via the second API, and the DMS 110-b may receive a response to the query via the second API associated with the SaaS application 205-c, where the second schema is detected based at least in part on the response. In some such examples, at 440, the DMS 110-b may convert the one or more second respective DAOs into the target restore data table of the second schema. In some such examples, at 445, the DMS 110-b may restore, via the second API associated with the SaaS application 205-c, the target restore data table to the SaaS application 205-c.

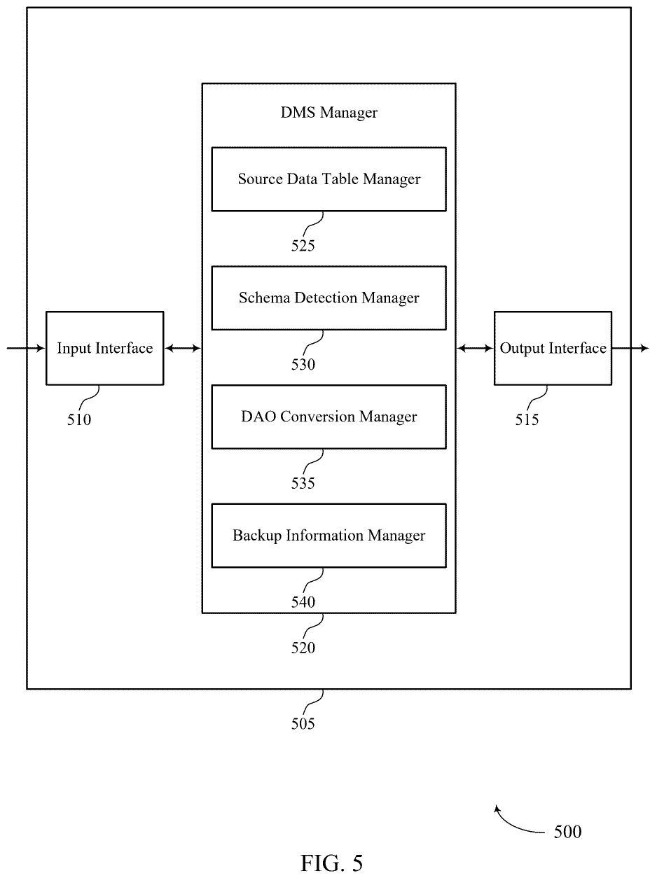

FIG. 5 shows a block diagram 500 of a system 505 that supports dynamic DAOs for data backup and recovery in accordance with aspects of the present disclosure. In some examples, the system 505 may be an example of aspects of one or more components described with reference to FIG. 1, such as a DMS 110. The system 505 may include an input interface 510, an output interface 515, and a DMS manager 520. The system 505 may also include one or more processors. Each of these components may be in communication with one another (e.g., via one or more buses, communications links, communications interfaces, or any combination thereof).

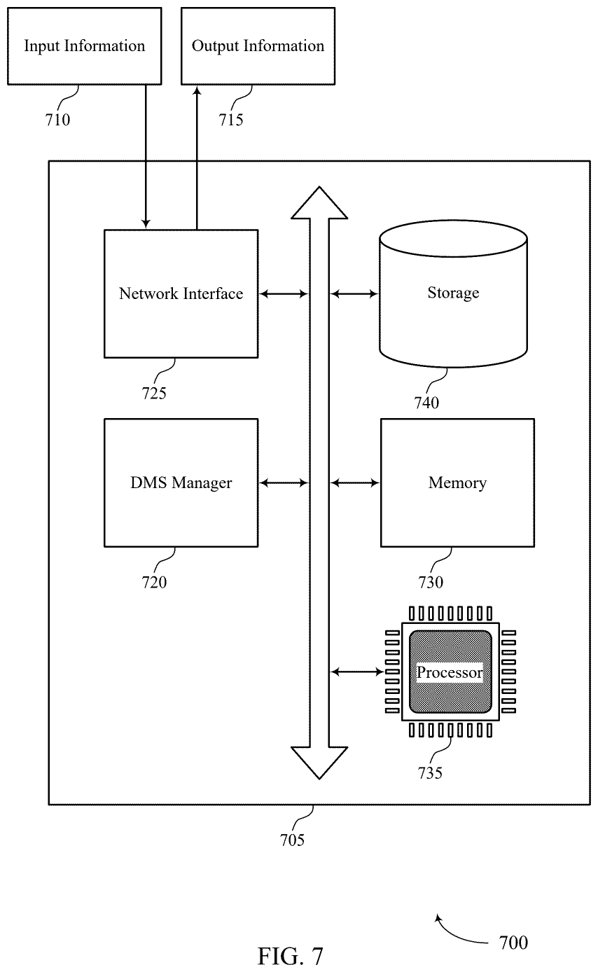

The input interface 510 may manage input signaling for the system 505. For example, the input interface 510 may receive input signaling (e.g., messages, packets, data, instructions, commands, or any other form of encoded information) from other systems or devices. The input interface 510 may send signaling corresponding to (e.g., representative of or otherwise based on) such input signaling to other components of the system 505 for processing. For example, the input interface 510 may transmit such corresponding signaling to the DMS manager 520 to support dynamic DAOs for data backup and recovery. In some cases, the input interface 510 may be a component of a network interface 725 as described with reference to FIG. 7.

The output interface 515 may manage output signaling for the system 505. For example, the output interface 515 may receive signaling from other components of the system 505, such as the DMS manager 520, and may transmit such output signaling corresponding to (e.g., representative of or otherwise based on) such signaling to other systems or devices. In some cases, the output interface 515 may be a component of a network interface 725 as described with reference to FIG. 7.

For example, the DMS manager 520 may include a source data table manager 525, a schema detection manager 530, a DAO conversion manager 535, a backup information manager 540, or any combination thereof. In some examples, the DMS manager 520, or various components thereof, may be configured to perform various operations (e.g., receiving, monitoring, transmitting) using or otherwise in cooperation with the input interface 510, the output interface 515, or both. For example, the DMS manager 520 may receive information from the input interface 510, send information to the output interface 515, or be integrated in combination with the input interface 510, the output interface 515, or both to receive information, transmit information, or perform various other operations as described herein.

The source data table manager 525 may be configured as or otherwise support a means for obtaining, by a DMS, a source data table from a SaaS application via an API associated with the SaaS application, the source data table including one or more rows of data values. The schema detection manager 530 may be configured as or otherwise support a means for detecting, by the DMS, a schema of the source data table, the schema including a set of fields. The DAO conversion manager 535 may be configured as or otherwise support a means for converting, by the DMS and based on detecting the schema, the one or more rows of the source data table into one or more respective DAOs that map the set of fields to corresponding data values per row of the one or more rows. The backup information manager 540 may be configured as or otherwise support a means for causing, by the DMS, backup information for the SaaS application to be stored in a storage environment accessible to the DMS, where the backup information for the SaaS application is based on the one or more respective DAOs.

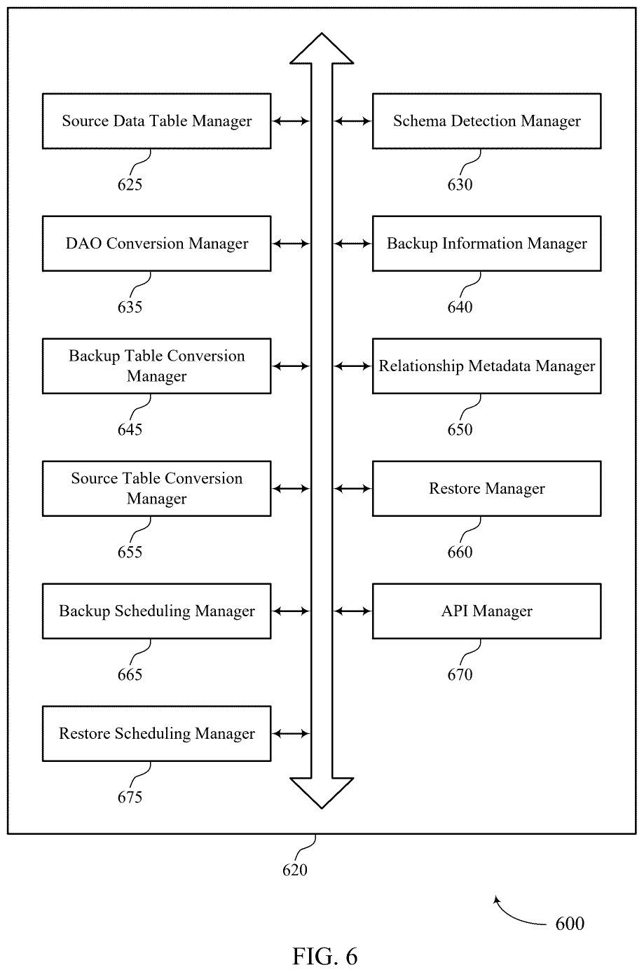

FIG. 6 shows a block diagram 600 of a DMS manager 620 that supports dynamic DAOs for data backup and recovery in accordance with aspects of the present disclosure. The DMS manager 620 may be an example of aspects of a DMS manager or a DMS manager 520, or both, as described herein. The DMS manager 620, or various components thereof, may be an example of means for performing various aspects of dynamic DAOs for data backup and recovery as described herein. For example, the DMS manager 620 may include a source data table manager 625, a schema detection manager 630, a DAO conversion manager 635, a backup information manager 640, a backup table conversion manager 645, a relationship metadata manager 650, a source table conversion manager 655, a restore manager 660, a backup scheduling manager 665, an API manager 670, a restore scheduling manager 675, or any combination thereof. Each of these components, or components of subcomponents thereof (e.g., one or more processors, one or more memories), may communicate, directly or indirectly, with one another (e.g., via one or more buses, communications links, communications interfaces, or any combination thereof).

The source data table manager 625 may be configured as or otherwise support a means for obtaining, by a DMS, a source data table from a SaaS application via an API associated with the SaaS application, the source data table including one or more rows of data values. The schema detection manager 630 may be configured as or otherwise support a means for detecting, by the DMS, a schema of the source data table, the schema including a set of fields. The DAO conversion manager 635 may be configured as or otherwise support a means for converting, by the DMS and based on detecting the schema, the one or more rows of the source data table into one or more respective DAOs that map the set of fields to corresponding data values per row of the one or more rows. The backup information manager 640 may be configured as or otherwise support a means for causing, by the DMS, backup information for the SaaS application to be stored in a storage environment accessible to the DMS, where the backup information for the SaaS application is based on the one or more respective DAOs.

In some examples, the backup table conversion manager 645 may be configured as or otherwise support a means for converting, by the DMS, the one or more respective DAOs into one or more backup tables having a second schema, where causing the backup information to be stored in the storage environment includes causing the one or more backup tables having the second schema to be stored in the storage environment. In some examples, the one or more backup tables having the second schema are Postgres tables.

In some examples, the source data table manager 625 may be configured as or otherwise support a means for obtaining, by the DMS, a second source data table from the SaaS application via a second API associated with the SaaS application, the second source data table including one or more second rows of data values. In some examples, the schema detection manager 630 may be configured as or otherwise support a means for detecting, by the DMS, a second schema of the second source data table, the second schema including a second set of fields different than the set of fields. In some examples, the DAO conversion manager 635 may be configured as or otherwise support a means for converting, by the DMS and based on detecting the second schema, the one or more second rows of the second source data table into one or more second respective DAOs that map the second set of fields to corresponding second data values per row of the one or more second rows. In some examples, the backup information manager 640 may be configured as or otherwise support a means for causing, by the DMS, second backup information for the SaaS application to be stored in the storage environment or a second storage environment accessible to the DMS, where the second backup information for the SaaS application is based on the one or more second respective DAOs.

In some examples, the source data table manager 625 may be configured as or otherwise support a means for obtaining, by the DMS, a second source data table from a second SaaS application via a second API associated with the second SaaS application, the second source data table including one or more second rows of data values. In some examples, the schema detection manager 630 may be configured as or otherwise support a means for detecting, by the DMS, a second schema of the second source data table, the second schema including a second set of fields. In some examples, the DAO conversion manager 635 may be configured as or otherwise support a means for converting, by the DMS and based on detecting the second schema, the one or more second rows of the second source data table into one or more second respective DAOs that map the second set of fields to corresponding second data values per row of the one or more second rows. In some examples, the backup information manager 640 may be configured as or otherwise support a means for causing, by the DMS, second backup information for the second SaaS application to be stored in the storage environment or a second storage environment accessible to the DMS, where the second backup information for the SaaS application is based on the one or more second respective DAOs.

In some examples, the source data table manager 625 may be configured as or otherwise support a means for obtaining, by the DMS, a second version of the source data table from the SaaS application via the API associated with the SaaS application and at a second time, where the second version of the source data table obtained at the second time includes one or more second rows of data values. In some examples, the schema detection manager 630 may be configured as or otherwise support a means for detecting, by the DMS, a second schema of the second version of the source data table, the second schema including a second set of fields different than the set of fields. In some examples, the DAO conversion manager 635 may be configured as or otherwise support a means for converting, by the DMS and based on detecting the second schema, the one or more second rows of the second version of the source data table into one or more second respective DAOs that map the second set of fields to corresponding second data values per row of the one or more second rows. In some examples, the backup information manager 640 may be configured as or otherwise support a means for causing, by the DMS, second backup information for the SaaS application to be stored in the storage environment or a second storage environment accessible to the DMS, where the second backup information for the SaaS application is based on the one or more second respective DAOs. In some examples, the second set of fields includes a first additional field with respect to the set of fields. In some examples, the set of fields includes a second additional field with respect to the second set of fields.

In some examples, the one or more respective DAOs indicate respective field types and respective field names for the set of fields.

In some examples, the relationship metadata manager 650 may be configured as or otherwise support a means for detecting, by the DMS, relationship metadata associated with the source data table, where the relationship metadata is indicative of a hierarchical relationship between a row of the one or more rows and a second data table, where converting the one or more rows includes indicating the relationship metadata in a respective DAO for the row of the one or more respective DAOs.

In some examples, the backup information manager 640 may be configured as or otherwise support a means for obtaining, by the DMS and from the storage environment, second backup information for a target restore data table of the SaaS application that corresponds to a target restore time. In some examples, the DAO conversion manager 635 may be configured as or otherwise support a means for converting, by the DMS, the second backup information for the SaaS application into one or more second respective DAOs that map a second set of fields of the second backup information to corresponding second data values per row of one or more second rows of the second backup information. In some examples, the schema detection manager 630 may be configured as or otherwise support a means for detecting, by the DMS, a second schema for the target restore data table, the second schema including a third set of fields. In some examples, the source table conversion manager 655 may be configured as or otherwise support a means for converting, by the DMS, the one or more second respective DAOs into the target restore data table of the second schema. In some examples, the restore manager 660 may be configured as or otherwise support a means for restoring, by the DMS and via a second API associated with the SaaS application, the target restore data table to the SaaS application.

In some examples, the API manager 670 may be configured as or otherwise support a means for performing, by the DMS, a query to the SaaS application for the target restore data table via the second API. In some examples, the API manager 670 may be configured as or otherwise support a means for receiving, by the DMS, a response to the query via the second API associated with the SaaS application, where the second schema is detected based on the response.

In some examples, the restore scheduling manager 675 may be configured as or otherwise support a means for receiving, by the DMS and via a user interface associated with the DMS, a request to restore the target restore data table of the SaaS application to a state corresponding to the target restore time.

In some examples, the backup scheduling manager 665 may be configured as or otherwise support a means for receiving, by the DMS and via a user interface associated with the DMS, a request to back up the source data table of the SaaS application at a first time, where obtaining the source data table is at the first time and is based on the request.

FIG. 7 shows a block diagram 700 of a system 705 that supports dynamic DAOs for data backup and recovery in accordance with aspects of the present disclosure. The system 705 may be an example of or include components of a system 505 as described herein. The system 705 may include components for data management, including components such as a DMS manager 720, an input information 710, an output information 715, a network interface 725, at least one memory 730, at least one processor 735, and a storage 740. These components may be in electronic communication or otherwise coupled with each other (e.g., operatively, communicatively, functionally, electronically, electrically; via one or more buses, communications links, communications interfaces, or any combination thereof). Additionally, the components of the system 705 may include corresponding physical components or may be implemented as corresponding virtual components (e.g., components of one or more virtual machines). In some examples, the system 705 may be an example of aspects of one or more components described with reference to FIG. 1, such as a DMS 110.

The network interface 725 may enable the system 705 to exchange information (e.g., input information 710, output information 715, or both) with other systems or devices (not shown). For example, the network interface 725 may enable the system 705 to connect to a network (e.g., a network 120 as described herein). The network interface 725 may include one or more wireless network interfaces, one or more wired network interfaces, or any combination thereof. In some examples, the network interface 725 may be an example of may be an example of aspects of one or more components described with reference to FIG. 1, such as one or more network interfaces 165.

Memory 730 may include RAM, ROM, or both. The memory 730 may store computer-readable, computer-executable software including instructions that, when executed, cause the processor 735 to perform various functions described herein. In some cases, the memory 730 may contain, among other things, a basic input/output system (BIOS), which may control basic hardware or software operation such as the interaction with peripheral components or devices. In some cases, the memory 730 may be an example of aspects of one or more components described with reference to FIG. 1, such as one or more memories 175.

The processor 735 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 735 may be configured to execute computer-readable instructions stored in a memory 730 to perform various functions (e.g., functions or tasks supporting dynamic DAOs for data backup and recovery). Though a single processor 735 is depicted in the example of FIG. 7, it is to be understood that the system 705 may include any quantity of one or more of processors 735 and that a group of processors 735 may collectively perform one or more functions ascribed herein to a processor, such as the processor 735. In some cases, the processor 735 may be an example of aspects of one or more components described with reference to FIG. 1, such as one or more processors 170.

Storage 740 may be configured to store data that is generated, processed, stored, or otherwise used by the system 705. In some cases, the storage 740 may include one or more HDDs, one or more SDDs, or both. In some examples, the storage 740 may be an example of a single database, a distributed database, multiple distributed databases, a data store, a data lake, or an emergency backup database. In some examples, the storage 740 may be an example of one or more components described with reference to FIG. 1, such as one or more network disks 180.

For example, the DMS manager 720 may be configured as or otherwise support a means for obtaining, by a DMS, a source data table from a SaaS application via an API associated with the SaaS application, the source data table including one or more rows of data values. The DMS manager 720 may be configured as or otherwise support a means for detecting, by the DMS, a schema of the source data table, the schema including a set of fields. The DMS manager 720 may be configured as or otherwise support a means for converting, by the DMS and based on detecting the schema, the one or more rows of the source data table into one or more respective DAOs that map the set of fields to corresponding data values per row of the one or more rows. The DMS manager 720 may be configured as or otherwise support a means for causing, by the DMS, backup information for the SaaS application to be stored in a storage environment accessible to the DMS, where the backup information for the SaaS application is based on the one or more respective DAOs.

By including or configuring the DMS manager 720 in accordance with examples as described herein, the system 705 may support techniques for dynamic DAOs for data backup and recovery, which may provide one or more benefits such as, for example, improved reliability, reduced latency, more efficient utilization of computing resources, network resources or both, and improved scalability, among other possibilities.

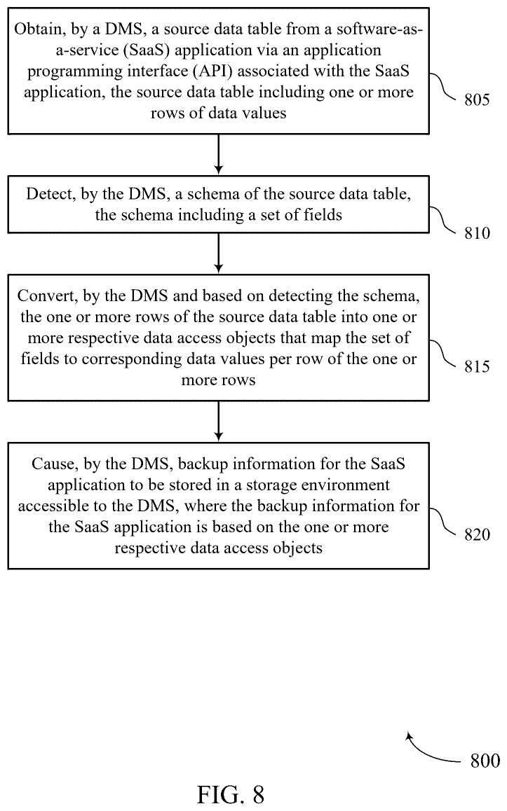

FIG. 8 shows a flowchart illustrating a method 800 that supports dynamic DAOs for data backup and recovery in accordance with aspects of the present disclosure. The operations of the method 800 may be implemented by a DMS or its components as described herein. For example, the operations of the method 800 may be performed by a DMS as described with reference to FIGS. 1 through 7. In some examples, a DMS may execute a set of instructions to control the functional elements of the DMS to perform the described functions. Additionally, or alternatively, the DMS may perform aspects of the described functions using special-purpose hardware.

At 805, the method may include obtaining, by a DMS, a source data table from a SaaS application via an API associated with the SaaS application, the source data table including one or more rows of data values. The operations of 805 may be performed in accordance with examples as disclosed herein. In some examples, aspects of the operations of 805 may be performed by a source data table manager 625 as described with reference to FIG. 6.

At 810, the method may include detecting, by the DMS, a schema of the source data table, the schema including a set of fields. The operations of 810 may be performed in accordance with examples as disclosed herein. In some examples, aspects of the operations of 810 may be performed by a schema detection manager 630 as described with reference to FIG. 6.

At 815, the method may include converting, by the DMS and based on detecting the schema, the one or more rows of the source data table into one or more respective DAOs that map the set of fields to corresponding data values per row of the one or more rows. The operations of 815 may be performed in accordance with examples as disclosed herein. In some examples, aspects of the operations of 815 may be performed by a DAO conversion manager 635 as described with reference to FIG. 6.

At 820, the method may include causing, by the DMS, backup information for the SaaS application to be stored in a storage environment accessible to the DMS, where the backup information for the SaaS application is based on the one or more respective DAOs.

The operations of 820 may be performed in accordance with examples as disclosed herein. In some examples, aspects of the operations of 820 may be performed by a backup information manager 640 as described with reference to FIG. 6.

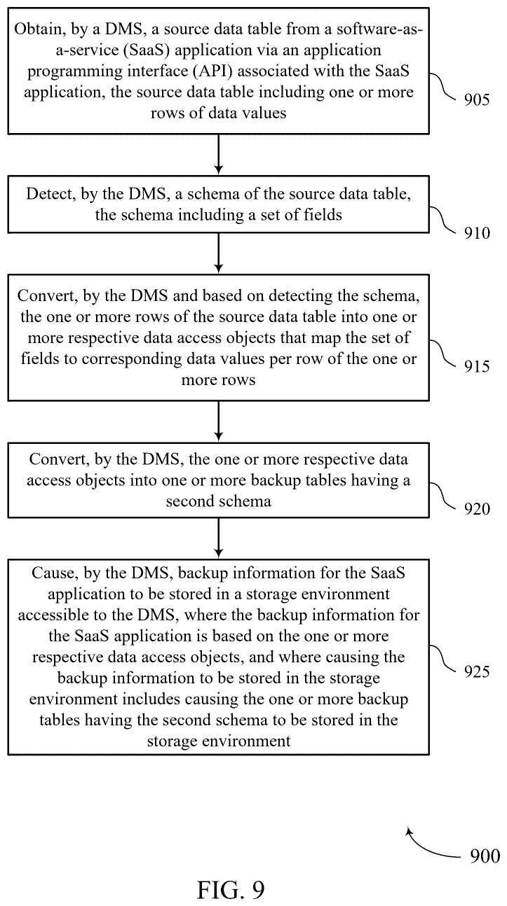

FIG. 9 shows a flowchart illustrating a method 900 that supports dynamic DAOs for data backup and recovery in accordance with aspects of the present disclosure. The operations of the method 900 may be implemented by a DMS or its components as described herein. For example, the operations of the method 900 may be performed by a DMS as described with reference to FIGS. 1 through 7. In some examples, a DMS may execute a set of instructions to control the functional elements of the DMS to perform the described functions. Additionally, or alternatively, the DMS may perform aspects of the described functions using special-purpose hardware.

At 905, the method may include obtaining, by a DMS, a source data table from a SaaS application via an API associated with the SaaS application, the source data table including one or more rows of data values. The operations of 905 may be performed in accordance with examples as disclosed herein. In some examples, aspects of the operations of 905 may be performed by a source data table manager 625 as described with reference to FIG. 6.

At 910, the method may include detecting, by the DMS, a schema of the source data table, the schema including a set of fields. The operations of 910 may be performed in accordance with examples as disclosed herein. In some examples, aspects of the operations of 910 may be performed by a schema detection manager 630 as described with reference to FIG. 6.

At 915, the method may include converting, by the DMS and based on detecting the schema, the one or more rows of the source data table into one or more respective DAOs that map the set of fields to corresponding data values per row of the one or more rows. The operations of 915 may be performed in accordance with examples as disclosed herein. In some examples, aspects of the operations of 915 may be performed by a DAO conversion manager 635 as described with reference to FIG. 6.

At 920, the method may include converting, by the DMS, the one or more respective DAOs into one or more backup tables having a second schema. The operations of 920 may be performed in accordance with examples as disclosed herein. In some examples, aspects of the operations of 920 may be performed by a backup table conversion manager 645 as described with reference to FIG. 6.

At 925, the method may include causing, by the DMS, backup information for the SaaS application to be stored in a storage environment accessible to the DMS, where the backup information for the SaaS application is based on the one or more respective DAOs, and where causing the backup information to be stored in the storage environment includes causing the one or more backup tables having the second schema to be stored in the storage environment. The operations of 925 may be performed in accordance with examples as disclosed herein. In some examples, aspects of the operations of 925 may be performed by a backup information manager 640 as described with reference to FIG. 6.

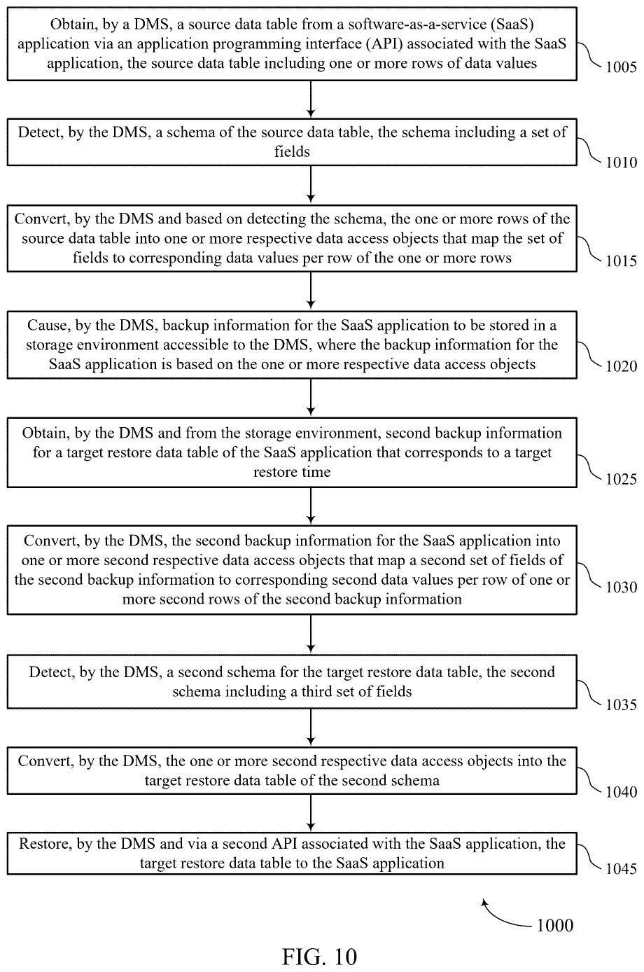

FIG. 10 shows a flowchart illustrating a method 1000 that supports dynamic DAOs for data backup and recovery in accordance with aspects of the present disclosure. The operations of the method 1000 may be implemented by a DMS or its components as described herein. For example, the operations of the method 1000 may be performed by a DMS as described with reference to FIGS. 1 through 7. In some examples, a DMS may execute a set of instructions to control the functional elements of the DMS to perform the described functions. Additionally, or alternatively, the DMS may perform aspects of the described functions using special-purpose hardware.

At 1005, the method may include obtaining, by a DMS, a source data table from a SaaS application via an API associated with the SaaS application, the source data table including one or more rows of data values. The operations of 1005 may be performed in accordance with examples as disclosed herein. In some examples, aspects of the operations of 1005 may be performed by a source data table manager 625 as described with reference to FIG. 6.

At 1010, the method may include detecting, by the DMS, a schema of the source data table, the schema including a set of fields. The operations of 1010 may be performed in accordance with examples as disclosed herein. In some examples, aspects of the operations of 1010 may be performed by a schema detection manager 630 as described with reference to FIG. 6.

At 1015, the method may include converting, by the DMS and based on detecting the schema, the one or more rows of the source data table into one or more respective DAOs that map the set of fields to corresponding data values per row of the one or more rows. The operations of 1015 may be performed in accordance with examples as disclosed herein. In some examples, aspects of the operations of 1015 may be performed by a DAO conversion manager 635 as described with reference to FIG. 6.

At 1020, the method may include causing, by the DMS, backup information for the SaaS application to be stored in a storage environment accessible to the DMS, where the backup information for the SaaS application is based on the one or more respective DAOs.

The operations of 1020 may be performed in accordance with examples as disclosed herein. In some examples, aspects of the operations of 1020 may be performed by a backup information manager 640 as described with reference to FIG. 6.

At 1025, the method may include obtaining, by the DMS and from the storage environment, second backup information for a target restore data table of the SaaS application that corresponds to a target restore time. The operations of 1025 may be performed in accordance with examples as disclosed herein. In some examples, aspects of the operations of 1025 may be performed by a backup information manager 640 as described with reference to FIG. 6.

At 1030, the method may include converting, by the DMS, the second backup information for the SaaS application into one or more second respective DAOs that map a second set of fields of the second backup information to corresponding second data values per row of one or more second rows of the second backup information. The operations of 1030 may be performed in accordance with examples as disclosed herein. In some examples, aspects of the operations of 1030 may be performed by a DAO conversion manager 635 as described with reference to FIG. 6.

At 1035, the method may include detecting, by the DMS, a second schema for the target restore data table, the second schema including a third set of fields. The operations of 1035 may be performed in accordance with examples as disclosed herein. In some examples, aspects of the operations of 1035 may be performed by a schema detection manager 630 as described with reference to FIG. 6.

At 1040, the method may include converting, by the DMS, the one or more second respective DAOs into the target restore data table of the second schema. The operations of 1040 may be performed in accordance with examples as disclosed herein. In some examples, aspects of the operations of 1040 may be performed by a source table conversion manager 655 as described with reference to FIG. 6.

At 1045, the method may include restoring, by the DMS and via a second API associated with the SaaS application, the target restore data table to the SaaS application. The operations of 1045 may be performed in accordance with examples as disclosed herein. In some examples, aspects of the operations of 1045 may be performed by a restore manager 660 as described with reference to FIG. 6.

The following provides an overview of aspects of the present disclosure:
Aspect 1: A method, comprising: obtaining, by a DMS, a source data table from a SaaS application via an API associated with the SaaS application, the source data table comprising one or more rows of data values; detecting, by the DMS, a schema of the source data table, the schema comprising a set of fields; converting, by the DMS and based at least in part on detecting the schema, the one or more rows of the source data table into one or more respective DAOs that map the set of fields to corresponding data values per row of the one or more rows; and causing, by the DMS, backup information for the SaaS application to be stored in a storage environment accessible to the DMS, wherein the backup information for the SaaS application is based at least in part on the one or more respective DAOs.
Aspect 2: The method of aspect 1, further comprising: converting, by the DMS, the one or more respective DAOs into one or more backup tables having a second schema, wherein causing the backup information to be stored in the storage environment comprises causing the one or more backup tables having the second schema to be stored in the storage environment.
Aspect 3: The method of aspect 2, wherein the one or more backup tables having the second schema are Postgres tables.
Aspect 4: The method of any of aspects 1 through 3, further comprising: obtaining, by the DMS, a second source data table from the SaaS application via a second API associated with the SaaS application, the second source data table comprising one or more second rows of data values; detecting, by the DMS, a second schema of the second source data table, the second schema comprising a second set of fields different than the set of fields; converting, by the DMS and based at least in part on detecting the second schema, the one or more second rows of the second source data table into one or more second respective DAOs that map the second set of fields to corresponding second data values per row of the one or more second rows; and causing, by the DMS, second backup information for the SaaS application to be stored in the storage environment or a second storage environment accessible to the DMS, wherein the second backup information for the SaaS application is based at least in part on the one or more second respective DAOs.
Aspect 5: The method of any of aspects 1 through 4, further comprising: obtaining, by the DMS, a second source data table from a second SaaS application via a second API associated with the second SaaS application, the second source data table comprising one or more second rows of data values; detecting, by the DMS, a second schema of the second source data table, the second schema comprising a second set of fields; converting, by the DMS and based at least in part on detecting the second schema, the one or more second rows of the second source data table into one or more second respective DAOs that map the second set of fields to corresponding second data values per row of the one or more second rows; and causing, by the DMS, second backup information for the second SaaS application to be stored in the storage environment or a second storage environment accessible to the DMS, wherein the second backup information for the SaaS application is based at least in part on the one or more second respective DAOs.
Aspect 6: The method of any of aspects 1 through 5, further comprising: obtaining, by the DMS, a second version of the source data table from the SaaS application via the API associated with the SaaS application and at a second time, wherein the second version of the source data table obtained at the second time comprises one or more second rows of data values; detecting, by the DMS, a second schema of the second version of the source data table, the second schema comprising a second set of fields different than the set of fields; converting, by the DMS and based at least in part on detecting the second schema, the one or more second rows of the second version of the source data table into one or more second respective DAOs that map the second set of fields to corresponding second data values per row of the one or more second rows; and causing, by the DMS, second backup information for the SaaS application to be stored in the storage environment or a second storage environment accessible to the DMS, wherein the second backup information for the SaaS application is based at least in part on the one or more second respective DAOs.
Aspect 7: The method of aspect 6, wherein the second set of fields comprises a first additional field with respect to the set of fields; or the set of fields comprises a second additional field with respect to the second set of fields.
Aspect 8: The method of any of aspects 1 through 7, wherein the one or more respective DAOs indicate respective field types and respective field names for the set of fields.
Aspect 9: The method of any of aspects 1 through 8, further comprising: detecting, by the DMS, relationship metadata associated with the source data table, wherein the relationship metadata is indicative of a hierarchical relationship between a row of the one or more rows and a second data table, wherein converting the one or more rows comprises indicating the relationship metadata in a respective DAO for the row of the one or more respective DAOs.
Aspect 10: The method of any of aspects 1 through 9, further comprising: obtaining, by the DMS and from the storage environment, second backup information for a target restore data table of the SaaS application that corresponds to a target restore time; converting, by the DMS, the second backup information for the SaaS application into one or more second respective DAOs that map a second set of fields of the second backup information to corresponding second data values per row of one or more second rows of the second backup information; detecting, by the DMS, a second schema for the target restore data table, the second schema comprising a third set of fields; converting, by the DMS, the one or more second respective DAOs into the target restore data table of the second schema; and restoring, by the DMS and via a second API associated with the SaaS application, the target restore data table to the SaaS application.
Aspect 11: The method of aspect 10, further comprising: performing, by the DMS, a query to the SaaS application for the target restore data table via the second API; and receiving, by the DMS, a response to the query via the second API associated with the SaaS application, wherein the second schema is detected based at least in part on the response.
Aspect 12: The method of any of aspects 10 through 11, further comprising: receiving, by the DMS and via a user interface associated with the DMS, a request to restore the target restore data table of the SaaS application to a state corresponding to the target restore time.
Aspect 13: The method of any of aspects 1 through 12, further comprising: receiving, by the DMS and via a user interface associated with the DMS, a request to back up the source data table of the SaaS application at a first time, wherein obtaining the source data table is at the first time and is based at least in part on the request.
Aspect 14: An apparatus comprising one or more memories storing processor-executable code, and one or more processors coupled with the one or more memories and individually or collectively operable to execute the code to cause the apparatus to perform a method of any of aspects 1 through 13.
Aspect 15: An apparatus comprising at least one means for performing a method of any of aspects 1 through 13.
Aspect 16: A non-transitory computer-readable medium storing code the code comprising instructions executable by one or more processors to perform a method of any of aspects 1 through 13.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Further, a system as used herein may be a collection of devices, a single device, or aspects within a single device.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, “a component” having characteristics or performing functions may refer to “at least one of one or more components” having a particular characteristic or performing a particular function. Subsequent reference to a component introduced with the article “a” using the terms “the” or “said” refers to any or all of the one or more components. For example, a component introduced with the article “a” shall be understood to mean “one or more components,” and referring to “the component” subsequently in the claims shall be understood to be equivalent to referring to “at least one of the one or more components.” Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method, comprising:
obtaining, by a data management system (DMS), a source data table from a software-as-a-service (Saas) application via an application programming interface (API) associated with the SaaS application, the source data table comprising one or more rows of data values;
detecting, by the DMS, a schema of the source data table, the schema comprising a set of fields;
converting, by the DMS and based at least in part on detecting the schema, the one or more rows of the source data table into one or more respective data access objects that map the set of fields to corresponding data values per row of the one or more rows; and
causing, by the DMS, backup information for the SaaS application to be stored in a storage environment accessible to the DMS, wherein the backup information for the SaaS application is based at least in part on the one or more respective data access objects.

2. The method of claim 1, further comprising:
converting, by the DMS, the one or more respective data access objects into one or more backup tables having a second schema, wherein causing the backup information to be stored in the storage environment comprises causing the one or more backup tables having the second schema to be stored in the storage environment.

3. The method of claim 2, wherein the one or more backup tables having the second schema are Postgres tables.

4. The method of claim 1, further comprising:
obtaining, by the DMS, a second source data table from the SaaS application via a second API associated with the SaaS application, the second source data table comprising one or more second rows of data values;
detecting, by the DMS, a second schema of the second source data table, the second schema comprising a second set of fields different than the set of fields;
converting, by the DMS and based at least in part on detecting the second schema, the one or more second rows of the second source data table into one or more second respective data access objects that map the second set of fields to corresponding second data values per row of the one or more second rows; and
causing, by the DMS, second backup information for the SaaS application to be stored in the storage environment or a second storage environment accessible to the DMS, wherein the second backup information for the SaaS application is based at least in part on the one or more second respective data access objects.

5. The method of claim 1, further comprising:
obtaining, by the DMS, a second source data table from a second SaaS application via a second API associated with the second SaaS application, the second source data table comprising one or more second rows of data values;
detecting, by the DMS, a second schema of the second source data table, the second schema comprising a second set of fields;
converting, by the DMS and based at least in part on detecting the second schema, the one or more second rows of the second source data table into one or more second respective data access objects that map the second set of fields to corresponding second data values per row of the one or more second rows; and
causing, by the DMS, second backup information for the second SaaS application to be stored in the storage environment or a second storage environment accessible to the DMS, wherein the second backup information for the SaaS application is based at least in part on the one or more second respective data access objects.

6. The method of claim 1, further comprising:
obtaining, by the DMS, a second version of the source data table from the SaaS application via the API associated with the SaaS application and at a second time, wherein the second version of the source data table obtained at the second time comprises one or more second rows of data values;
detecting, by the DMS, a second schema of the second version of the source data table, the second schema comprising a second set of fields different than the set of fields;
converting, by the DMS and based at least in part on detecting the second schema, the one or more second rows of the second version of the source data table into one or more second respective data access objects that map the second set of fields to corresponding second data values per row of the one or more second rows; and
causing, by the DMS, second backup information for the SaaS application to be stored in the storage environment or a second storage environment accessible to the DMS, wherein the second backup information for the SaaS application is based at least in part on the one or more second respective data access objects.

7. The method of claim 6, wherein:
the second set of fields comprises a first additional field with respect to the set of fields; or
the set of fields comprises a second additional field with respect to the second set of fields.

8. The method of claim 1, wherein the one or more respective data access objects indicate respective field types and respective field names for the set of fields.

9. The method of claim 1, further comprising:
detecting, by the DMS, relationship metadata associated with the source data table, wherein the relationship metadata is indicative of a hierarchical relationship between a row of the one or more rows and a second data table, wherein converting the one or more rows comprises indicating the relationship metadata in a respective data access object for the row of the one or more respective data access objects.

10. The method of claim 1, further comprising:
obtaining, by the DMS and from the storage environment, second backup information for a target restore data table of the SaaS application that corresponds to a target restore time;
converting, by the DMS, the second backup information for the SaaS application into one or more second respective data access objects that map a second set of fields of the second backup information to corresponding second data values per row of one or more second rows of the second backup information;
detecting, by the DMS, a second schema for the target restore data table, the second schema comprising a third set of fields;
converting, by the DMS, the one or more second respective data access objects into the target restore data table of the second schema; and
restoring, by the DMS and via a second API associated with the SaaS application, the target restore data table to the SaaS application.

11. The method of claim 10, further comprising:
performing, by the DMS, a query to the SaaS application for the target restore data table via the second API; and
receiving, by the DMS, a response to the query via the second API associated with the SaaS application, wherein the second schema is detected based at least in part on the response.

12. The method of claim 10, further comprising:
receiving, by the DMS and via a user interface associated with the DMS, a request to restore the target restore data table of the SaaS application to a state corresponding to the target restore time.

13. The method of claim 1, further comprising:
receiving, by the DMS and via a user interface associated with the DMS, a request to back up the source data table of the SaaS application at a first time, wherein obtaining the source data table is at the first time and is based at least in part on the request.

14. An apparatus, comprising:
one or more memories storing processor-executable code; and
one or more processors coupled with the one or more memories and individually or collectively operable to execute the code to cause the apparatus to:
obtain, by a data management system (DMS), a source data table from a software-as-a-service (SaaS) application via an application programming interface (API) associated with the SaaS application, the source data table comprising one or more rows of data values;
detect, by the DMS, a schema of the source data table, the schema comprising a set of fields;
convert, by the DMS and based at least in part on detecting the schema, the one or more rows of the source data table into one or more respective data access objects that map the set of fields to corresponding data values per row of the one or more rows; and
cause, by the DMS, backup information for the SaaS application to be stored in a storage environment accessible to the DMS, wherein the backup information for the SaaS application is based at least in part on the one or more respective data access objects.

15. The apparatus of claim 14, wherein the one or more processors are individually or collectively further operable to execute the code to cause the apparatus to:
convert, by the DMS, the one or more respective data access objects into one or more backup tables having a second schema, wherein, to cause the backup information to be stored in the storage environment, the one or more processors are individually or collectively further operable to execute the code to cause the apparatus to cause the one or more backup tables having the second schema to be stored in the storage environment.

16. The apparatus of claim 14, wherein the one or more processors are individually or collectively further operable to execute the code to cause the apparatus to:
obtain, by the DMS, a second source data table from the SaaS application via a second API associated with the SaaS application, the second source data table comprising one or more second rows of data values;
detect, by the DMS, a second schema of the second source data table, the second schema comprising a second set of fields different than the set of fields;
convert, by the DMS and based at least in part on detecting the second schema, the one or more second rows of the second source data table into one or more second respective data access objects that map the second set of fields to corresponding second data values per row of the one or more second rows; and
cause, by the DMS, second backup information for the SaaS application to be stored in the storage environment or a second storage environment accessible to the DMS, wherein the second backup information for the SaaS application is based at least in part on the one or more second respective data access objects.

17. The apparatus of claim 14, wherein the one or more processors are individually or collectively further operable to execute the code to cause the apparatus to:
obtain, by the DMS, a second source data table from a second SaaS application via a second API associated with the second SaaS application, the second source data table comprising one or more second rows of data values;
detect, by the DMS, a second schema of the second source data table, the second schema comprising a second set of fields;
convert, by the DMS and based at least in part on detecting the second schema, the one or more second rows of the second source data table into one or more second respective data access objects that map the second set of fields to corresponding second data values per row of the one or more second rows; and
cause, by the DMS, second backup information for the second SaaS application to be stored in the storage environment or a second storage environment accessible to the DMS, wherein the second backup information for the SaaS application is based at least in part on the one or more second respective data access objects.

18. The apparatus of claim 14, wherein the one or more processors are individually or collectively further operable to execute the code to cause the apparatus to:
obtain, by the DMS, a second version of the source data table from the SaaS application via the API associated with the SaaS application and at a second time, wherein the second version of the source data table obtained at the second time comprises one or more second rows of data values;
detect, by the DMS, a second schema of the second version of the source data table, the second schema comprising a second set of fields different than the set of fields;
convert, by the DMS and based at least in part on detecting the second schema, the one or more second rows of the second version of the source data table into one or more second respective data access objects that map the second set of fields to corresponding second data values per row of the one or more second rows; and
cause, by the DMS, second backup information for the SaaS application to be stored in the storage environment or a second storage environment accessible to the DMS, wherein the second backup information for the SaaS application is based at least in part on the one or more second respective data access objects.

19. The apparatus of claim 14, wherein the one or more processors are individually or collectively further operable to execute the code to cause the apparatus to:
obtain, by the DMS and from the storage environment, second backup information for a target restore data table of the SaaS application that corresponds to a target restore time;
convert, by the DMS, the second backup information for the SaaS application into one or more second respective data access objects that map a second set of fields of the second backup information to corresponding second data values per row of one or more second rows of the second backup information;
detect, by the DMS, a second schema for the target restore data table, the second schema comprising a third set of fields;
convert, by the DMS, the one or more second respective data access objects into the target restore data table of the second schema; and
restore, by the DMS and via a second API associated with the SaaS application, the target restore data table to the SaaS application.

20. A non-transitory computer-readable medium storing code, the code comprising instructions executable by one or more processors to:
obtain, by a data management system (DMS), a source data table from a software-as-a-service (Saas) application via an application programming interface (API) associated with the SaaS application, the source data table comprising one or more rows of data values;
detect, by the DMS, a schema of the source data table, the schema comprising a set of fields;
convert, by the DMS and based at least in part on detecting the schema, the one or more rows of the source data table into one or more respective data access objects that map the set of fields to corresponding data values per row of the one or more rows; and
cause, by the DMS, backup information for the SaaS application to be stored in a storage environment accessible to the DMS, wherein the backup information for the SaaS application is based at least in part on the one or more respective data access objects.
